(19) United States
(12) Patent Application Publication
(10) Pub. No.: US 2018/0146346 A1
(43) Pub. Date: May 24, 2018

(54) INSTANCE SPECIFIC, SENDER SELECTED MESSAGE BEARING AUDIO/VIDEO NOTIFICATION SYSTEM AND METHOD

(71) Applicant: CHERRY SWEEP LTD, Kiryat Ono (IL)

(72) Inventors: Anat LITAN SEVER, Kiryat Ono (IL); Asi LIYAM SELIM MUGRABI, Givatayim (IL)

(73) Assignee: CHERRY SWEEP LTD, Kiryat Ono (IL)

(21) Appl. No.: 15/357,226

(22) Filed: Nov. 21, 2016

(51) Int. Cl. H04W 4/12; H04M 1/725

(52) U.S. Cl. CPC H04W 4/12; H04M 1/72547

(57) ABSTRACT

A communications method including enabling selection and sending by a sending user, using a sending communication device, of a sending user-selectable, at least partially audio communication, which was previously stored, the sending user-selectable at least partially audio communication being selectable by the sending user from a library accessible to the sending user via the sending communication device, enabling playing to a receiving user, using a receiving communication device, the sending user-selected, at least partially audio communication and enabling automatically displaying to the receiving user, using the receiving communication device, at least one receiving user-selectable at least partially audio reply communication, which was previously stored and which is subject matter related to the sending user-selected at least partially audio communication.

### FIELD OF THE INVENTION

The present invention relates to communications methods and systems generally.

### BACKGROUND OF THE INVENTION

Various types of communications methods and systems are known.

### SUMMARY OF THE INVENTION

The present invention seeks to provide easy to use communications systems and methods.

There is thus provided in accordance with a preferred embodiment of the present invention a communications method including enabling selection and sending by a sending user, using a sending communication device, of a sending user-selectable, at least partially audio communication, which was previously stored, the sending user-selectable at least partially audio communication being selectable by the sending user from a library accessible to the sending user via the sending communication device, enabling playing, to a receiving user using a receiving communication device, the sending user-selected, at least partially audio communication and enabling automatically displaying to the receiving user, using the receiving communication device, at least one receiving user-selectable at least partially audio reply communication, which was previously stored and which is subject matter related to the sending user-selected at least partially audio communication.

There is also provided in accordance with another preferred embodiment of the present invention a communications method including enabling sending by a sending user using a sending communication device in an online state a sending user-selected, at least partially audio communication, which was previously stored, the sending user-selected at least partially audio communication being selected by the sending user from a library accessible to the sending user via the sending communication device and enabling playing to a receiving user using a receiving communication device in an offline state, at least an audio portion of the sender-selected, at least partially audio communication.

Preferably, the communications method also includes enabling automatically displaying to the receiving user, using the receiving communication device, at least one receiving user-selectable at least partially audio reply communication, which was previously stored and which is subject matter related to the sending user-selected at least partially audio communication.

Preferably, the communications method also includes enabling replying by the receiving user, using the receiving communication device, by sending a receiving user selected, at least partially audio communication, which was previously stored.

In accordance with a preferred embodiment of the present invention at least one of the sender-selectable at least partially audio communication and the receiving user-selectable reply communication includes an Instance Specific, Sender Selected Message Bearing Audio/Video Notification (ISSSMBAVN). Additionally, the ISSSMBAVN includes an indication of an ISSSMBAVN classification. Additionally, the enabling automatically displaying to the receiving user, using the receiving communication device, at least one receiving user-selectable reply communication, which was previously stored and which is subject matter related to the sending user-selected at least partially audio communication ISSSMBAVN employs the indication of the ISSSMBAVN classification.

Preferably, the enabling playing to the receiving user includes enabling playing to the receiving user via the receiving communication device at least an audio portion of the at least partially audio communication when the receiving communication device is in an offline state.

In accordance with a preferred embodiment of the present invention the sending by the sending user includes sending an originating Instance Specific, Sender Selected Message Bearing Audio/Video Notification (ISSSMBAVN) and the replying by the receiving user, using the receiving communication device, includes sending an initial response ISSSMBAVN. Additionally, the sending by the sending user also includes sending a subsequent Instance Specific, Sender Selected Message Bearing Audio/Video Notification (ISSSMBAVN). Additionally, the replying by the receiving user, using the receiving communication device, also includes sending a further response ISSSMBAVN.

Preferably, the ISSSMBAVN includes a unique ISSSMBAVN ID which identifies an ISSSMBAVN and includes an indication of an ISSSMBAVN classification, a unique SENDER ID which identifies the sending user's ISSSMBAVN Mobile Application and a unique RECEIVER ID which identifies the receiving user's ISSSMBAVN Mobile Application.

There is further provided in accordance with yet another preferred embodiment of the present invention a communications system including at least one server being configured to enable selection and sending by a sending user, using a sending communication device, of a sending user-selectable, at least partially audio communication, which was previously stored, the sending user-selectable at least partially audio communication being selectable by the sending user from a library accessible to the sending user via the sending communication device, the at least one server also being configured to enable playing to a receiving user using a receiving communication device, the sending user-selected, at least partially audio communication and enable automatically displaying to the receiving user, using the receiving communication device, at least one receiving user-selectable at least partially audio reply communication, which was previously stored and which is subject matter related to the sending user-selected at least partially audio communication.

Preferably, the server also is configured to enable replying by the receiving user, using the receiving communication device, by sending a receiving user selected, at least partially audio communication, which was previously stored.

In accordance with a preferred embodiment of the present invention at least one of the sender-selectable at least partially audio communication and the receiving user-selectable reply communication includes a Instance Specific, Sender Selected Message Bearing Audio/Video Notification (ISSSMBAVN). Additionally, the ISSSMBAVN includes an indication of an ISSSMBAVN classification. Additionally, the server is configured to enable automatically displaying to the receiving user, using the receiving communication device, at least one receiving user-selectable reply communication, which was previously stored and which is subject matter related to the sending user-selected at least partially audio communication ISSSMBAVN employs the indication of the ISSSMBAVN classification.

In accordance with a preferred embodiment of the present invention the server enables playing to the receiving user includes enabling playing to the receiving user via the receiving communication device at least an audio portion of the at least partially audio communication when the receiving communication device is in an offline state.

Preferably, the server is operative such that the sending by the sending user includes sending an originating Instance Specific, Sender Selected Message Bearing Audio/Video Notification (ISSSMBAVN) and the replying by the receiving user, using the receiving communication device, includes sending an initial response ISSSMBAVN. Additionally, the server is operative such that the sending by the sending user also includes sending a subsequent Instance Specific, Sender Selected Message Bearing Audio/Video Notification (ISSSMBAVN). Additionally, the server is operative such that the replying by the receiving user, using the receiving communication device, also includes sending a further response ISSSMBAVN.

In accordance with a preferred embodiment of the present invention the ISSSMBAVN includes a unique ISSSMBAVN ID which identifies an ISSSMBAVN and includes an indication of an ISSSMBAVN classification, a unique SENDER ID which identifies the sending user's ISSSMBAVN Mobile Application and a unique RECEIVER ID which identifies the receiving user's ISSSMBAVN Mobile Application.

There is even further provided in accordance with still another preferred embodiment of the present invention a communications system including a server configured to enable sending, by a sending user using a sending communication device in an online state, a sending user-selected, at least partially audio communication, which was previously stored, the sending user-selected at least partially audio communication being selected by the sending user from a library accessible to the sending user via the sending communication device and playing to a receiving user using a receiving communication device in an offline state, at least an audio portion of the sender-selected, at least partially audio communication.

In accordance with a preferred embodiment of the present invention the server is operative to enable selection by a sending user, using a sending communication device, of a sending user-selectable, at least partially audio communication, which was previously stored, the sending user-selectable at least partially audio communication being selectable by the sending user from a library accessible to the sending user via the sending communication device and to enable automatically displaying to the receiving user, using the receiving communication device, at least one receiving user-selectable at least partially audioreply communication, which was previously stored and which is subject matter related to the sending user-selected at least partially audio communication.

Preferably, the server is also operative to enable replying by the receiving user, using the receiving communication device, by sending a receiving user selected, at least partially audio communication, which was previously stored.

In accordance with a preferred embodiment of the present invention at least one of the sender-selected at least partially audio communication and the receiving user-selected reply communication includes a Instance Specific, Sender Selected Message Bearing Audio/Video Notification (ISSSMBAVN). Additionally, the ISSSMBAVN includes a unique ISSSMBAVN ID which identifies an ISSSMBAVN and includes an indication of an ISSSMBAVN classification, a unique SENDER ID which identifies the sending user's ISSSMBAVN Mobile Application and a unique RECEIVER ID which identifies the receiving user's ISSSMBAVN Mobile Application. Additionally, the enabling automatically displaying to the receiving user, using the receiving communication device, at least one receiving user-selectable reply communication, which was previously stored and which is subject matter related to the sending user-selected at least partially audio communication ISSSMBAVN employs the indication of the ISSSMBAVN classification.

Preferably, the sending by the sending user includes sending an originating Instance Specific, Sender Selected Message Bearing Audio/Video Notification (ISSSMBAVN) and the replying by the receiving user, using the receiving communication device, includes sending an initial response ISSSMBAVN. Additionally, the sending by the sending user also includes sending a subsequent Instance Specific, Sender Selected Message Bearing Audio/Video Notification (ISSSMBAVN). Additionally, the replying by the receiving user, using the receiving communication device, also includes sending a further response ISSSMBAVN.

In accordance with a preferred embodiment of the present invention the ISSSMBAVN includes a unique ISSSMBAVN ID which identifies an ISSSMBAVN and includes an indication of an ISSSMBAVN classification, a unique SENDER ID which identifies said sending user's ISSSMBAVN Mobile Application and a unique RECEIVER ID which identifies said receiving user's ISSSMBAVN Mobile Application.

### BRIEF DESCRIPTION OF THE DRAWINGS

The present invention will be more fully appreciated and understood from the following detailed description, taken in conjunction with the drawings in which:

FIGS. 1A-1C are together a simplified illustration of one example of communication via Instance Specific, Sender Selected Message Bearing Audio/Video Notifications (ISSSMBAVNs) in accordance with a preferred embodiment of the present invention;

FIGS. 2A-2C are together a simplified illustration of another example of communication via Instance Specific, Sender Selected Message Bearing Audio/Video Notifications (ISSSMBAVNs) in accordance with a preferred embodiment of the present invention;

FIG. 3 is a top level simplified functional block diagram of a communications system constructed and operative in accordance with a preferred embodiment of the present invention; and

FIGS. 4A, 4B and 4C are together a simplified flowchart illustrating operation of the communications system of a preferred embodiment of the present invention.

### DETAILED DESCRIPTION OF PREFERRED EMBODIMENTS

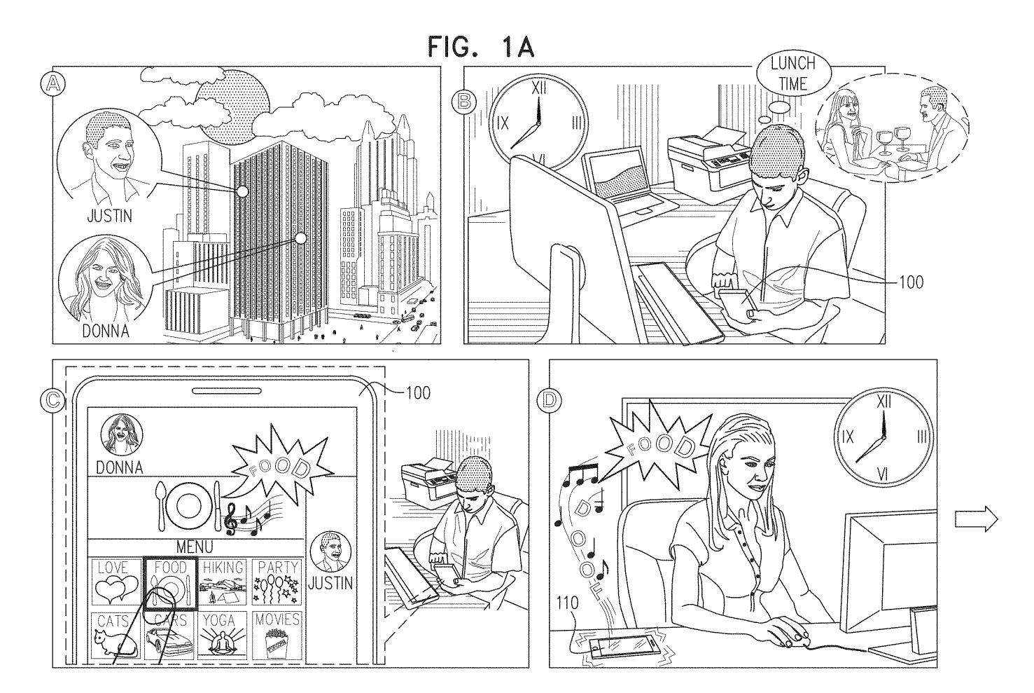

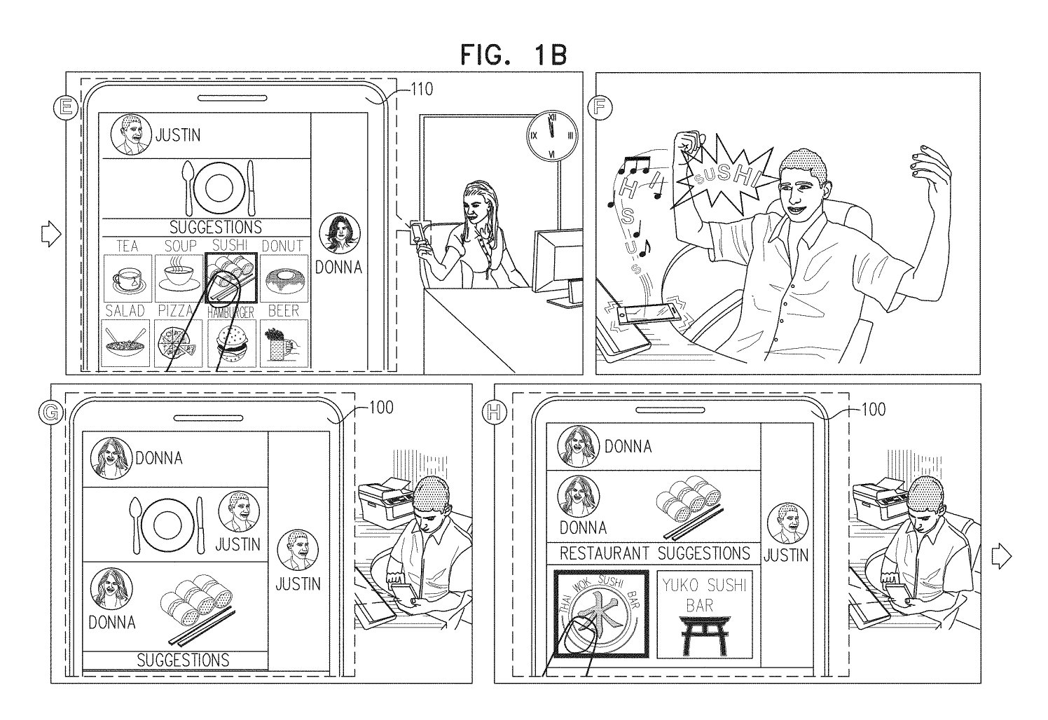

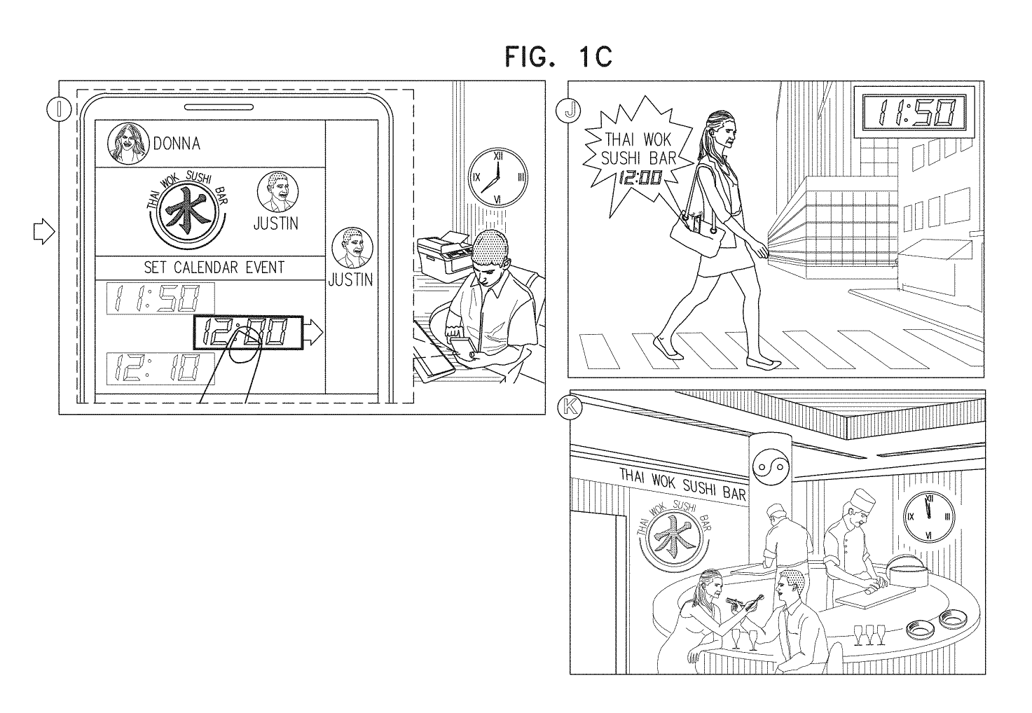

Reference is now made to FIGS. 1A-1C, which are together a simplified illustration of one example of communication via an Instance Specific, Sender Selected Message Bearing Audio/Video Notification (ISSSMBAVN) in accordance with a preferred embodiment of the present invention. As seen in FIG. 1A, a user, Justin, typically one of a number of employees sitting in cubicles in a workplace, senses that it is lunch time. Justin employs his mobile device 100, typically a smartphone, to send an Instance Specific, Sender Selected Message Bearing Audio/Video Notification (ISSSMBAVN) to a friend, Donna, in the same building. This ISSSMBAVN is here termed an Originating ISSSMBAVN.

An Instance Specific, Sender Selected Message Bearing Audio/Video Notification (ISSSMBAVNs) is hereby defined as a notification, which includes at least Audio and/or Video content. The ISSSMBAVN is specifically selected by a sender in each instance, preferably at the time of sending. As seen in frames B and C of FIG. 1A, Justin typically selects the ISSSMBAVN to be sent to Donna with a single click on an ISSSMBAVN menu.

The ISSSMBAVN preferably includes an audio portion, such as a singing rendition of “FOOD”, and may also, or alternatively, include a video portion, such as an animation or a picture.

As seen in Frame D of FIG. 1A, Donna receives the Originating ISSSMBAVN, sent by Justin, on her mobile device 110, typically a smartphone. It is appreciated that at least the audio portion and possibly also the video portion of the Originating ISSSMBAVN is played to Donna even if Donna's mobile device is currently off-line.

As seen in Frame E of FIG. 1B, after receiving the Originating ISSSMBAVN sent by Justin, Donna is presented with an Initial Response ISSSMBAVN menu on her mobile device 110, enabling her to select a type of food. By clicking on a type of food, here sushi, Donna sends an Initial Response ISSSMBAVN to Justin.

As seen in Frames F and G in FIG. 1B, Justin receives the Initial Response ISSSMBAVN sent by Donna on his mobile device 100, typically a singing rendition of “SUSHI”. It is appreciated that at least the audio portion and possibly also the video portion of the Initial Response ISSSMBAVN may be played to Justin even if Justin's mobile device is currently off-line. Here a picture of sushi appears.

As seen in Frame H of FIG. 1B, after receiving the Initial Response ISSSMBAVN sent by Donna, Justin is presented with a Further Response ISSSMBAVN menu on his mobile device 100, enabling him to select a sushi restaurant. By clicking on a given sushi restaurant, here Thai Wok Sushi Bar, Justin sends a Further Response ISSSMBAVN to Donna. As seen in Frame I of FIG. 1C, the Further Response ISSSMBAVN menu may also enable Justin to select or propose a meeting time. Alternatively or additionally, upon receipt of the Further Response ISSMBAVN from Justin, Donna may be presented with a Still Further Response ISSMBAVN menu enabling her to select or propose a meeting time.

As seen in Frame J of FIG. 1C, a reminder ISSMBAVN may be sent automatically, or by Justin, to Donna just before their meeting at an agreed time, as shown in Frame K in FIG. 1C.

It is appreciated that the ISSMBAVN communication can continue back and forth multiple additional times and with participation of more than two parties.

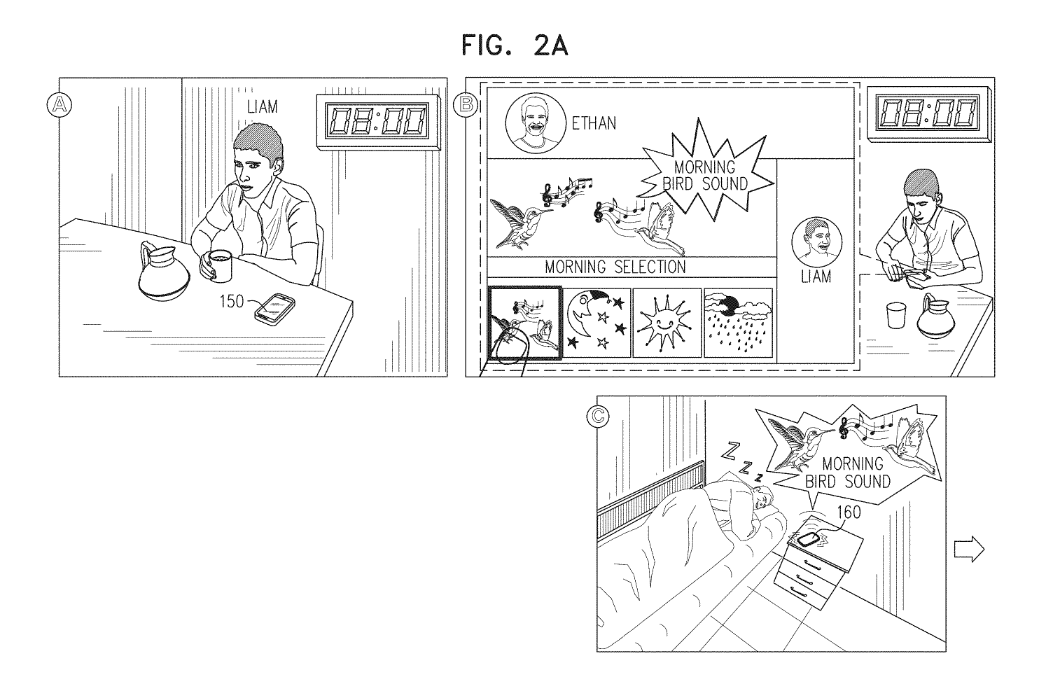

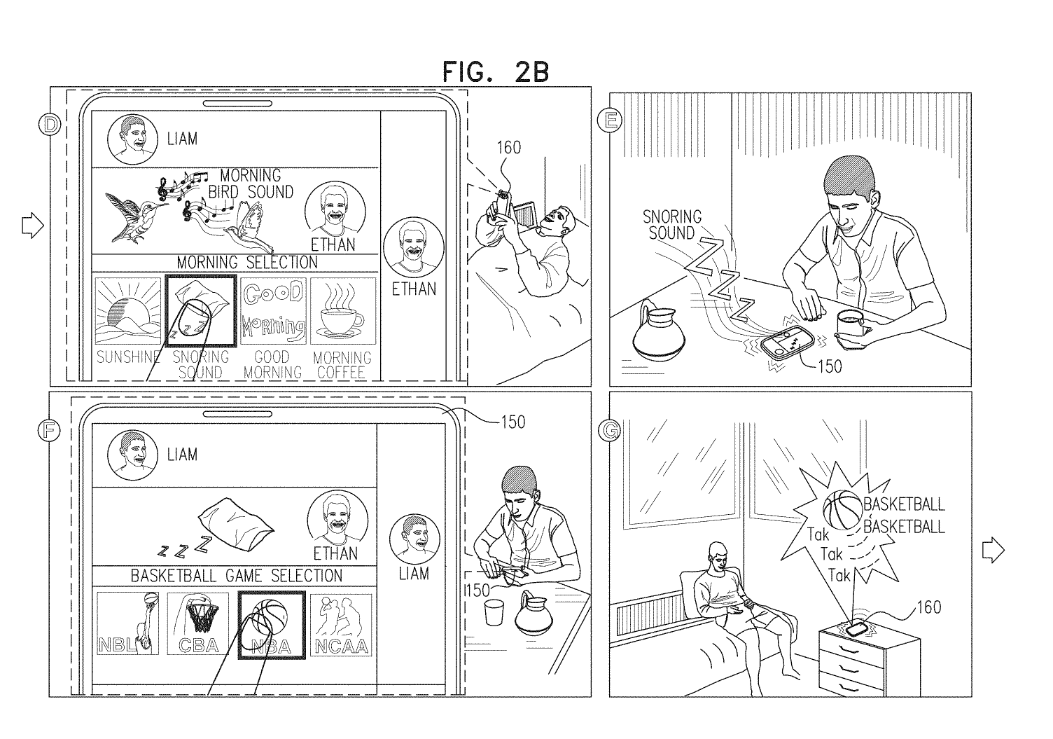

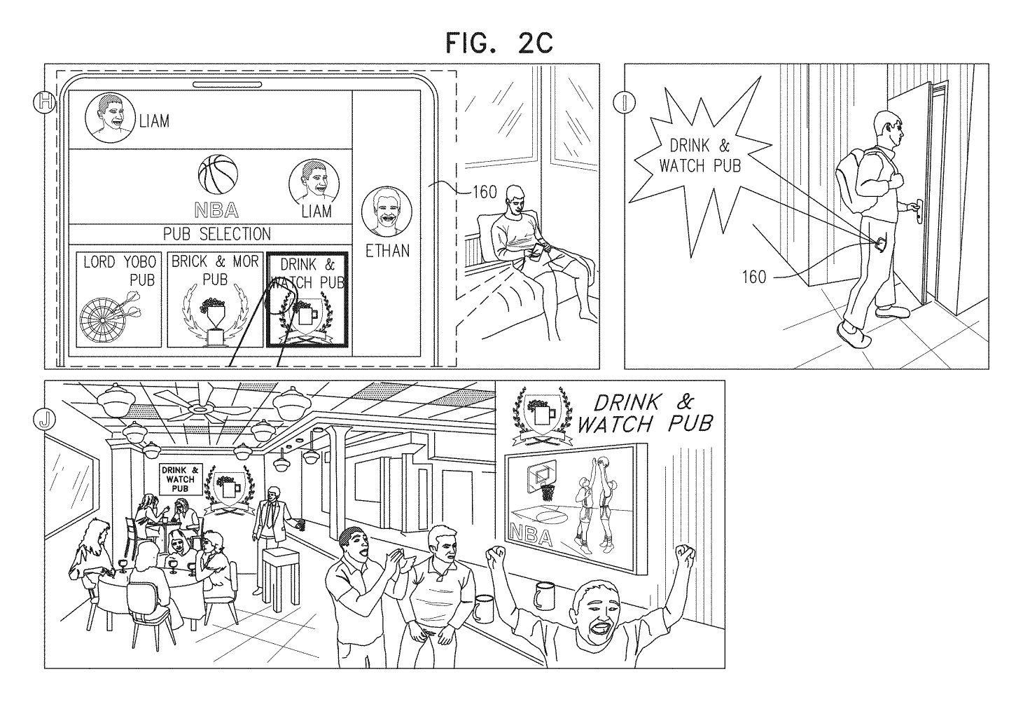

Reference is now made to FIGS. 2A-2C, which are together a simplified illustration of one example of communication via an Instance Specific, Sender Selected Message Bearing Audio/Video Notification (ISSSMBAVN) in accordance with another preferred embodiment of the present invention. As seen in FIG. 2A, a user, Liam, is having his morning coffee at 8:00 AM. Liam employs his mobile device 150, typically a smartphone, to send an Instance Specific, Sender Selected Message Bearing Audio/Video Notification (ISSSMBAVN) to a friend, Ethan, in the same building. This ISSSMBAVN is here termed an Originating ISSSMBAVN.

As in the preceding example, the Instance Specific, Sender Selected Message Bearing Audio/Video Notification (ISSSMBAVNs) is a notification, which includes at least Audio and/or Video content. The ISSSMBAVN is specifically selected by a sender in each instance, preferably at the time of sending. As seen in frames A and B of FIG. 2A, Liam typically selects the ISSSMBAVN to be sent to Ethan with a single click on an ISSSMBAVN menu, here typically showing ISSSMBAVNs appropriate for various times of day.

The ISSSMBAVN preferably includes an audio portion, such as bird sounds, and may also, or alternatively, include a video portion, such as an animation or a picture.

As seen in Frame C of FIG. 2A, Ethan receives the Originating ISSSMBAVN, sent by Justin, on his mobile device 160, typically a smartphone. It is appreciated that at least the audio portion and possibly also the video portion of the Originating ISSSMBAVN is played to Ethan even if Ethan's mobile device is currently off-line. Thus, Ethan may see the video portion and hear the audio portion of the Originating ISSSMBAVN without necessarily touching mobile device 160.

As seen in Frame D of FIG. 2B, after receiving the Originating ISSSMBAVN sent by Liam, Ethan is presented with an Initial Response ISSSMBAVN menu on his mobile device 160, enabling him to select a suitable, selectable stored response. By clicking on one of selectable stored response, here a snoring sound, Ethan sends an Initial Response ISSSMBAVN to Liam.

As seen in Frame E in FIG. 2B, Liam receives the Initial Response ISSSMBAVN sent by Ethan on his mobile device 150, here a snoring sound. It is appreciated that at least the audio portion and possibly also the video portion of the Initial Response ISSSMBAVN may be played to Liam even if Liam's mobile device is currently off-line. Here a picture of a pillow appears.

As seen in Frame F of FIG. 2B, after receiving the Initial Response ISSSMBAVN sent by Ethan, Liam is presented with a Further Response ISSSMBAVN menu on his mobile device 150, enabling him to propose an activity. By clicking on a logo representing a basketball game, here an NBA logo, Liam sends a Further Response ISSSMBAVN to Ethan. As seen in Frame G of FIG. 2B, the Further Response ISSSMBAVN is played to Ethan, who is now awake.

As seen in Frame H of FIG. 2C, after receiving the Further Response ISSSMBAVN sent by Liam, Ethan is presented with an Additional Response ISSSMBAVN menu on his mobile device 160, enabling him to propose an additional activity. By clicking on a logo representing a specific pub, Ethan sends an Additional Response ISSSMBAVN to Liam. Alternatively or additionally, upon receipt of the Further Response ISSMBAVN from Liam, Ethan may be presented with a Still Further Response ISSMBAVN menu enabling him to select or propose a meeting time.

As seen in Frame I of FIG. 2C, a reminder ISSMBAVN may be sent automatically or by Liam to Ethan just before their meeting at the pub at an agreed time, as shown in Frame J in FIG. 2C.

It is appreciated that the ISSMBAVN communication can continue back and forth multiple additional times and with participation of more than two parties.

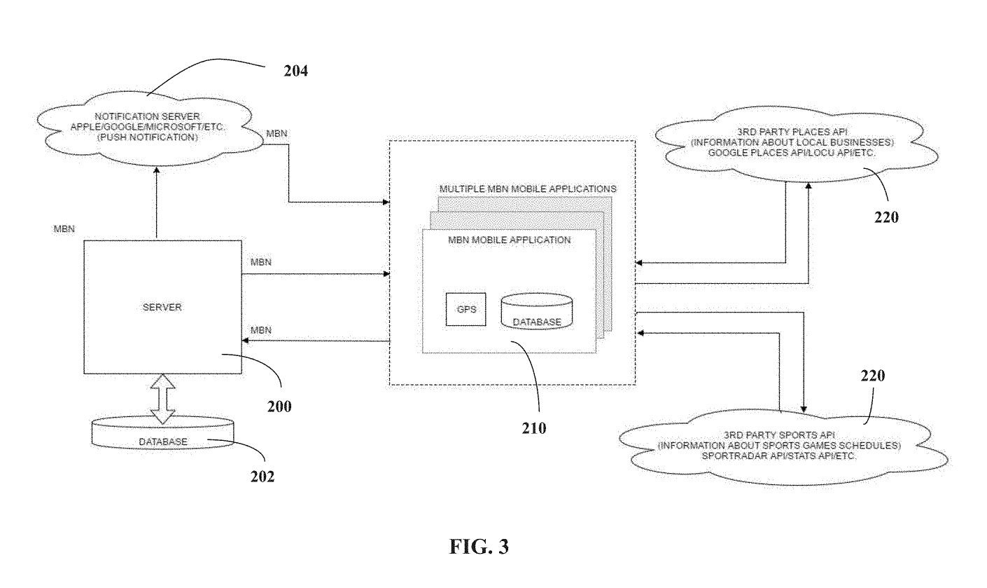

Reference is now made to FIG. 3, which is a simplified top level functional block diagram of a communications system constructed and operative in accordance with a preferred embodiment of the present invention.

As seen in FIG. 3, there is provided in accordance with a preferred embodiment of the present invention an Instance Specific, Sender Selected Message Bearing Audio/Video Notification (ISSSMBAVN) server 200, which communicates with a database 202 and with one or more notification servers 204, such as those operated by Apple, Google, Microsoft and other communication vendors. ISSSMBAVN server 200 is preferably on the Cloud but may be embodied in any other suitable computer resource.

In accordance with a preferred embodiment of the present invention, ISSSMBAVN server 200 sends and receives Instance Specific, Sender Selected Message Bearing Audio/Video Notification (ISSSMBAVNs (ISSSMBAVNs) respectively directly to and from a multiplicity of ISSSMBAVN Mobile Applications 210, which reside on a corresponding multiplicity of mobile communicators (not shown), such as smartphones. Additionally or alternatively, ISSSMBAVN server 200 sends and receives Instance Specific, Sender Selected Message Bearing Audio/Video Notifications (ISSSMBAVNs) respectively to and from a multiplicity of ISSSMBAVN Mobile Applications 210 via one or more notification servers 204, when a receiving user is off-line. In such a case, using conventional notification servers 204, the ISSSMBAVN Mobile Application only plays to the receiving user the audio file of the ISSSMBAVN and displays any text message but typically stores the entire ISSSMBAVN.

Alternatively, if the notification server 204 and the operating system of the user's mobile communicator are able to play the entire ISSSMBAVN when the user is offline, the entire ISSSMBAVN is played upon receipt thereof by the receiving user's ISSSMBAVN Mobile Application 210 even when the user is offline, unless the receiving user has muted his ISSSMBAVN Mobile Application. It is a particular feature of an embodiment of the present invention that a sending user may designate a specific ISSSMBAVN to a specific receiving user at a specific time as being mute and in such a case, the receiving user's ISSSMBAVN Mobile Application 210 will not play an audio file which is part of the ISSSMBAVN.

Preferably, when a designated receiving user is online, the ISSSMBAVN is sent directly by ISSSMBAVN server 200 to the receiving user. When the designated receiving user is offline, the ISSSMBAVN is sent via a notification server 204.

Preferably, when an ISSSMBAVN is played to the receiving user by the receiving user's ISSSMBAVN Mobile Application 210, the ISSSMBAVN Mobile Application 210 of the receiving user sends an acknowledgement to the ISSSMBAVN server 200, which in turn sends an acknowledgement to the ISSSMBAVN Mobile Application 210 of the sending user. The ISSSMBAVN server 200 preferably stores all relevant information regarding each sent and played ISSSMBAVN, including IDs of sending and receiving users' ISSSMBAVN Mobile Applications 210, time stamps of sending and playing and GPS locations of sending and receiving users.

Preferably, each of the ISSSMBAVN mobile applications utilizes GPS and database resources, which are present on the smartphone on which it is resident. The GPS resources are preferably employed for location awareness and the database resources are preferably employed for storing ISSSMBAVNs which may be viewed and sent by users.

Further in accordance with a preferred embodiment of the present invention, the ISSSMBAVN mobile applications cooperate with various APIs 220, such as a places API, which contains information about local businesses, such as GOOGLE PLACES API/LOCU, and an events API, which contains information about events, such as sports events and concerts, such as SPORTSTRADAR API and STATS API.

In accordance with a preferred embodiment of the present invention, when an ISSSMBAVN mobile application is open and in the foreground of a given mobile communicator, the user is considered to be online. Otherwise, the user is considered to be offline.

In accordance with a preferred embodiment of the present invention, each Instance Specific, Sender Selected Message Bearing Audio/Video Notification (ISSSMBAVN) includes some or all of the following elements:

A unique ISSSMBAVN ID which identifies the ISSSMBAVN being sent or received and which preferably specifies an audio file, an animation file and an ISSSMBAVN classification;

A unique SENDER ID which identifies the sending user's ISSSMBAVN Mobile Application 210; and

A unique RECEIVER ID which identifies the receiving user′ ISSSMBAVN Mobile Application 210.

Examples of ISSSMBAVN classifications include:
Invitations for food;
Invitations for activities;
Suggestions for specific food
Suggestions for specific eateries;
Suggestions for specific activities;
Suggestions for times/dates;
Suggestions for meeting places;
Greetings for various times of Day;
Expressions of various moods; and
Miscellaneous.

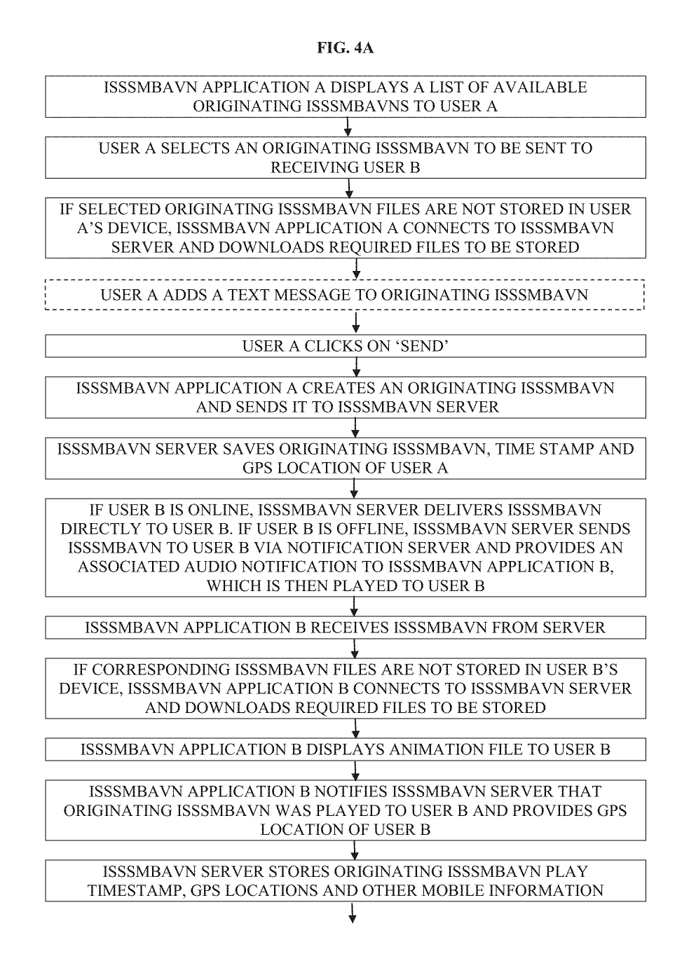

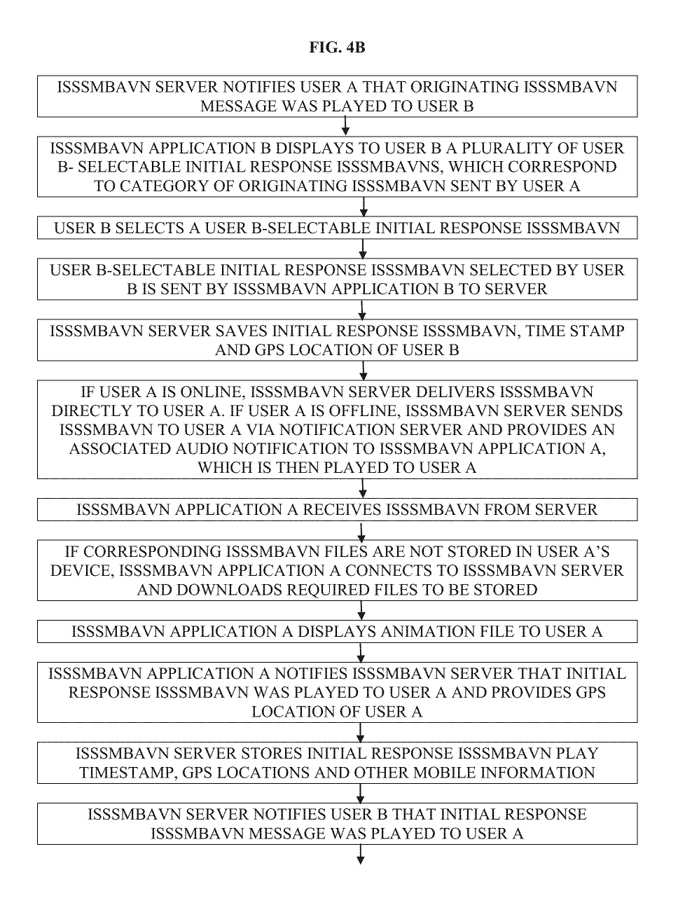

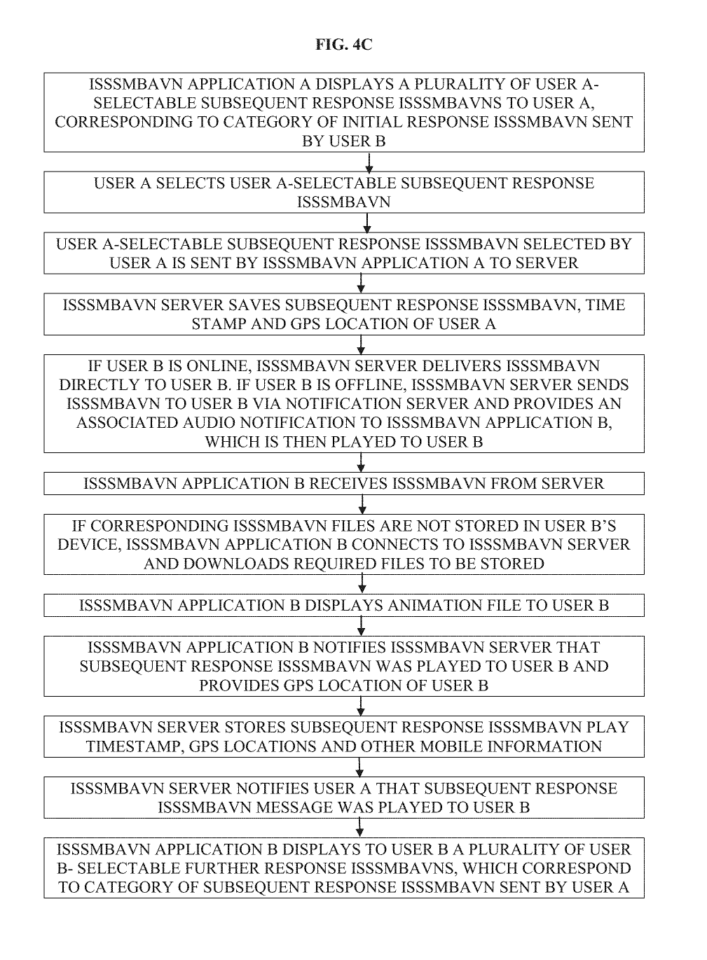

Reference is now made to FIGS. 4A, 4B and 4C, which are simplified flowcharts illustrating operation of the communications system of a preferred embodiment of the present invention, which employs animations with sound.

For the sake of conciseness, the following definitions are employed in the description which follows:
User A—a user who is using an ISSSMBAVN Application to initially send an ISSSMBAVN.
User B—a user who is using an ISSSMBAVN Application to initially receive an ISSSMBAVN—user B may be online or offline at the time of receiving the ISSSMBAVN from user A.
Device—a device capable of communication, such as a computer or a mobile communicator, such as a smartphone or a tablet.
ISSSMBAVN Application A—an ISSSMBAVN Application that user A is using.
ISSSMBAVN Application B—an ISSSMBAVN Application that user B is using.
ISSSMBAVN Interaction—A series of back and forth ISSSMBAVN communications between user A and user B which occur within a limited time duration.
Originating ISSSMBAVN—the initial ISSSMBAVN that user A sends to user B in an ISSSMBAVN interaction.
Initial Response ISSSMBAVN—the initial ISSSMBAVN that user B sends to user A in response to receipt of the Originating ISSSMBAVN.
Further Response ISSSMBAVN—a further ISSSMBAVN that user A or user B sends to another user in response to receipt of the an Initial Response ISSMBAVN or to a Further Response ISSSMBAVN.

In operation, ISSSMBAVN Application A displays to User A, a list of available Originating ISSSMBAVNs which can be selected and sent to other users, here “receiving users”, each having an ISSSMBAVN Application 210 installed on their devices, irrespective of whether the receiving user is online or offline.

The display can, for example, be a scrollable list of thumbnails of pictures, each representing a combination of a specific animation file with a specific sound file.

User A scrolls through available Originating ISSSMBAVN thumbnails displayed by ISSSMBAVN Application A and selects an Originating ISSSMBAVN thumbnail representing an Originating ISSSMBAVN to be sent to receiving user B.

ISSSMBAVN Application A checks if the selected Originating ISSSMBAVN thumbnail animation file and animation sound file is stored in user A's device. If not, ISSSMBAVN Application A connects to the ISSSMBAVN Server 200 and downloads the required files to ISSSMBAVN Application A to be stored thereat.

After selecting an Originating ISSSMBAVN thumbnail and optionally adding a text message, user A clicks on “Send”.

ISSSMBAVN Application A creates an Originating ISSSMBAVN, optionally including a text message, and sends it to ISSSMBAVN server 200.

Preferably, ISSSMBAVN server 200 saves the Originating ISSSMBAVN along with a time stamp and GPS location of User A and checks the online status of receiving user B.

If user B is offline, server 200 sends the ISSSMBAVN to User B via a notification server 204. Preferably, when user B is offline, server 200 provides an audio notification associated with the Originating ISSSMBAVN to ISSSMBAVN Application B, which is played to user B.

If user B is online, server 200 delivers the ISSSMBAVN directly to user B.

ISSSMBAVN Application B receives the ISSSMBAVN message from server 200 and checks whether the corresponding animation file and sound file are stored in ISSSMBAVN Application B. If not, ISSSMBAVN Application B preferably connects to server 200 and downloads the necessary files to User B's device to be stored thereat. Unless User A and User B are currently in correspondence via their respective ISSSMBAVN Applications, user B clicks on a suitable icon, such as a picture of User A, and an animation file, with or without sound, is displayed to user B.

Generally concurrently with playing of the animation file, ISSSMBAVN Application B notifies the ISSSMBAVN server 200 that the Originating ISSSMBAVN was played to User B and also provides the GPS location of User B to ISSSMBAVN server 200. In response, server 200 preferably:

stores an Originating ISSSMBAVN play timestamp and preferably other mobile information, typically including at least User A's and User B's GPS locations; and notifies user A that the Originating ISSSMBAVN message was played to user B; and

displays to user B, via ISSSMBAVN Application B, a plurality of user B-selectable thumbnails representing user B-selectable Initial Response ISSSMBAVNs, which correspond to the category of the Originating ISSSMBAVN originally sent by user A to user B, which category is indicated by the ISSSMBAVN ID.

In one example, if the Originating ISSSMBAVN sent by user A to user B was “FOOD” OR “I'M HUNGRY” as exemplified in FIG. 1A, the category of the Originating ISSSMBAVN is “food” and the user B-selectable thumbnails, representing user B-selectable Initial Response ISSSMBAVNs, correspond to the “food” category and represent various types of food, as seen at B in FIG. 1B.

In an alternative example, not illustrated, if the Originating ISSSMBAVN sent by user A to user B was “PIZZA”, the category of the Originating ISSSMBAVN is “pizza” and the user B-selectable thumbnails, representing user B-selectable Initial Response ISSSMBAVNs, correspond to the “pizza” category and represent various pizza shops or restaurants.

In another example, if the Originating ISSSMBAVN sent by user A to user B was a morning bird sound, as exemplified in FIG. 2A, the category of the Originating ISSSMBAVN is “morning greeting” and the user B-selectable thumbnails, representing user B-selectable Initial Response ISSSMBAVNs, correspond to the “morning greeting” category and represent various types of possible responses, as seen at D in FIG. 2B.

Once user B selects one of the user B-selectable thumbnails, typically by clicking on one of the user B-selectable thumbnails, the user B-selected Initial Response ISSSMBAVN corresponding to thumbnail clicked on by user B is sent by ISSSMBAVN application B to server 200.

Preferably, ISSSMBAVN server 200 saves the Initial Response ISSSMBAVN along with a time stamp and GPS location of User B and checks the online status of user A.

If user A is offline, server 200 sends the Initial Response ISSSMBAVN to User A via a notification server 204. Preferably, when user A is offline, server 200 provides an audio notification associated with the Initial Response ISSSMBAVN to ISSSMBAVN Application A, which is played to user A.

If user A is online, server 200 delivers the Initial Response ISSSMBAVN directly to user A.

ISSSMBAVN Application A receives the Initial Response ISSSMBAVN message from server 200 and checks whether the corresponding animation file and sound file are stored in ISSSMBAVN Application A. If not, ISSSMBAVN Application A preferably connects to server 200 and downloads the necessary files to User A's device to be stored thereat. Unless User A and User B are currently in correspondence via their respective ISSSMBAVN Applications, user A clicks on a suitable icon, such as a picture of User B, and the Initial Response ISSSMBAVN message, preferably an animation file, with or without sound, is played to user A.

Generally concurrently with playing of the animation file, ISSSMBAVN Application A notifies the ISSSMBAVN server 200 that the Initial Response ISSSMBAVN was played to User A and also provides the GPS location of User A to ISSSMBAVN server 200. In response, server 200 preferably:

stores an Initial Response ISSSMBAVN play timestamp and preferably other mobile information, typically including at least User A's and User B's GPS locations; and notifies user B that the Initial Response ISSSMBAVN message was played to user A; and

displays to user A, via ISSSMBAVN Application A, a plurality of user A-selectable thumbnails representing user A-selectable Subsequent Response ISSSMBAVNs, which correspond to the category of the Initial Response ISSSMBAVN sent by user B to user A, which category is indicated by the Initial Response ISSSMBAVN ID.

In a continuation of the first example described hereinabove with reference to FIGS. 1A & 1B, if the Initial Response ISSSMBAVN sent by user B to user A was “SUSHI” as exemplified in FIG. 1A, the category of the Initial Response ISSSMBAVN is “sushi” and the user A-selectable thumbnails, representing user A-selectable Subsequent Response ISSSMBAVNs, correspond to the “sushi” category and represent various sushi restaurants, as seen at H in FIG. 1B. It is appreciated that the display of various sushi restaurants may employ external APIs which may include, for example, pictures, menus and addresses of the various restaurants.

In an alternative example, if the Initial Response ISSSMBAVN sent by user B to user A was a given pizza shop, the category of the Initial Response ISSSMBAVN is “pizza shops” and the user A-selectable thumbnails, representing user A-selectable Subsequent Response ISSSMBAVNs, correspond to the “select time” category and represent various user A selectable meeting times.

In a continuation of the second example described hereinabove with reference to FIGS. 2A & 2B, if the Initial Response ISSSMBAVN sent by user B to user A was a snoring sound, as exemplified in FIG. 2B, the category of the Initial Response ISSSMBAVN is “select activity” and the user A-selectable thumbnails, representing user A-selectable Subsequent Response ISSSMBAVNs, correspond to the “select activity” category and represent various possible activities, as seen at F in FIG. 2B.

Once user A selects one of the user A-selectable thumbnails, typically by clicking on one of the user A-selectable thumbnails, the user A-selected Subsequent Response ISSSMBAVN corresponding to the thumbnail clicked on by user A is sent by ISSSMBAVN application A to server 200. It is appreciated that the Subsequent Response ISSSMBAVN may or may not include an animation file and a sound file.

Preferably, ISSSMBAVN server 200 saves the Subsequent Response ISSSMBAVN along with a time stamp and GPS location of User A and checks the online status of user B.

If user B is offline, server 200 sends the Subsequent Response ISSSMBAVN to User B via a notification server 204. Preferably, when user B is offline, server 200 provides an audio notification associated with the Subsequent Response ISSSMBAVN to ISSSMBAVN Application B, which is played to user B.

If user B is online, server 200 delivers the Subsequent Response ISSSMBAVN directly to user B.

ISSSMBAVN Application B receives the Subsequent Response ISSSMBAVN message from server 200 and checks whether a corresponding animation file and sound file are stored in ISSSMBAVN Application B. If not, ISSSMBAVN Application B preferably connects to server 200 and downloads the necessary files to User B's device to be stored thereat. Unless User A and User B are currently in correspondence via their respective ISSSMBAVN Applications, user B clicks on a suitable icon, such as a picture of User A, and the Subsequent ISSSMBAVN message, preferably an animation file, with or without sound, is played to user B.

Generally concurrently with playing of the animation file, ISSSMBAVN Application B notifies the ISSSMBAVN server 200 that the Subsequent Response ISSSMBAVN was played to User B and also provides the GPS location of User B to ISSSMBAVN server 200. In response, server 200 preferably:

stores a Subsequent Response ISSSMBAVN play timestamp and preferably other mobile information, typically including at least User A's and User B's GPS locations; and notifies user A that the Subsequent Response ISSSMBAVN message was played to user B; and

displays to user B, via ISSSMBAVN Application B, a plurality of user B-selectable thumbnails representing user B-selectable Further Response ISSSMBAVNs, which correspond to the category of the Subsequent Response ISSSMBAVN sent by user A to user B, which category is indicated by the Subsequent Response ISSSMBAVN ID.

In a further continuation of the first example described hereinabove with reference to FIGS. 1A & 1B, if the Subsequent Response ISSSMBAVN sent by user A to user B was “THAI WOK SUSHI BAR” as exemplified at H in FIG. 1B, the category of the Sequential Response ISSSMBAVN is “restaurant selection” and the user B-selectable thumbnails, representing user B-selectable Further Response ISSSMBAVNs, correspond to the “restaurant selection” category and represent various selectable dining times, as seen at I in FIG. 1C. It is appreciated that the display of various dining times at a given restaurant may employ external APIs which may include, for example, pictures, menus and reservation status of the selected restaurant.

In an alternative example, if the Subsequent Response ISSSMBAVN sent by user A to user B was a given pizza shop, the category of the Subsequent Response ISSSMBAVN is “select time” and the user B-selectable thumbnails, representing user B-selectable Further Response ISSSMBAVNs, correspond to the “select time” category and represent a meeting time to be confirmed by user B.

In a further continuation of the second example described hereinabove with reference to FIGS. 2A & 2B, if the Subsequent Response ISSSMBAVN sent by user A to user B was a NBA game selection, as exemplified at F in FIG. 2B, the category of the Further Response ISSSMBAVN is “select meeting place” and the user B-selectable thumbnails, representing user B-selectable Subsequent Response ISSSMBAVNs, correspond to the “select meeting place” category and represent various possible meeting places, as seen at H in FIG. 2C.

It is appreciated that the ISSSMBAVN interaction may include a lesser or greater number of ISSSMBAVN responses than indicated in the above examples. The system may also provide reminders, as indicated, for example, at J in FIG. 1C and at I in FIG. 2C.

It will be appreciated by persons skilled in the art that the present invention is not limited by what has been particularly shown and described hereinabove. Rather the scope of the present invention includes both combinations and subcombinations of features described hereinabove as well as modifications and variations thereof which are not in the prior art.

1. A communications method comprising:
enabling selection and sending by a sending user, using a sending communication device, of a sending user-selectable at least partially audio communication, which was previously stored, said sending user-selectable at least partially audio communication being selectable by the sending user from a library accessible to said sending user via said sending communication device;
enabling playing to a receiving user using a receiving communication device, said sending user-selectable, at least partially audio communication; and
enabling automatically displaying to said receiving user, using said receiving communication device, at least one receiving user-selectable at least partially audio reply communication, which was previously stored and which is subject matter related to said sending user-selectable at least partially audio communication.

2. A communications method according to claim 1 and also comprising:
enabling replying by said receiving user, using said receiving communication device, by sending a receiving user selected, at least partially audio communication, which was previously stored.

3. A communications method according to claim 1 and wherein at least one of said sender-selectable at least partially audio communication and said receiving user-selectable reply communication comprises an Instance Specific, Sender Selected Message Bearing Audio/Video Notification (ISSSMBAVN).

4. A communications method according to claim 3 and wherein said ISSSMBAVN comprises an indication of an ISSSMBAVN classification.

5. A communications method according to claim 4 and wherein said enabling automatically displaying to said receiving user, using said receiving communication device, at least one receiving user-selectable reply communication, which was previously stored and which is subject matter related to said sending user-selectable at least partially audio communication ISSSMBAVN employs said indication of said ISSSMBAVN classification.

6. A communications method according to claim 1 and wherein said enabling playing to said receiving user comprises enabling playing to said receiving user via said receiving communication device at least an audio portion of said at least partially audio communication when said receiving communication device is in an offline state.

7. A communications method according to claim 1 and wherein:
said sending by said sending user comprises sending an originating Instance Specific, Sender Selected Message Bearing Audio/Video Notification (ISSSMBAVN); and
said replying by said receiving user, using said receiving communication device, comprises sending an initial response ISSSMBAVN.

8. A communications method according to claim 7 and wherein:
said sending by said sending user also comprises sending a subsequent Instance Specific, Sender Selected Message Bearing Audio/Video Notification (ISSSMBAVN).

9. A communications method according to claim 8 and wherein:
said replying by said receiving user, using said receiving communication device, also comprises sending a further response ISSSMBAVN.

10. A communications method according to claim 6 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.

11. A communications method comprising:
enabling sending, by a sending user using a sending communication device in an online state, a sending user-selected, at least partially audio communication, which was previously stored, said sending user-selected at least partially audio communication being selected by the sending user from a library accessible to said sending user via said sending communication device; and
enabling playing, to a receiving user using a receiving communication device in an offline state, at least an audio portion of said sender-selected, at least partially audio communication.

12. A communications method according to claim 11 and also comprising:
enabling automatically displaying to said receiving user, using said receiving communication device, at least one receiving user-selectable at least partially audio reply communication, which was previously stored and which is subject matter related to said sending user-selected at least partially audio communication.

13. A communications method according to claim 11 and also comprising:
enabling replying by said receiving user, using said receiving communication device, by sending a receiving user selected, at least partially audio communication, which was previously stored.

14. A communications method according to claim 11 and wherein at least one of said sender-selected at least partially audio communication and said receiving user-selected reply communication comprises an Instance Specific, Sender Selected Message Bearing Audio/Video Notification (ISSSMBAVN).

15. A communications method according to claim 14 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.

16. A communications method according to claim 15 and wherein said enabling automatically displaying to said receiving user, using said receiving communication device, at least one receiving user-selectable reply communication, which was previously stored and which is subject matter related to said sending user-selected at least partially audio communication ISSSMBAVN employs said indication of said ISSSMBAVN classification.

17. A communications method according to claim 11 and wherein:
said sending by said sending user comprises sending an originating Instance Specific, Sender Selected Message Bearing Audio/Video Notification (ISSSMBAVN); and
said replying by said receiving user, using said receiving communication device, comprises sending an initial response ISSSMBAVN.

18. A communications method according to claim 17 and wherein:
said sending by said sending user also comprises sending a subsequent Instance Specific, Sender Selected Message Bearing Audio/Video Notification (ISSSMBAVN).

19. A communications method according to claim 18 and wherein:
said replying by said receiving user, using said receiving communication device, also comprises sending a further response ISSSMBAVN.

20. A communications method according to claim 6 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.

21. A communications system comprising:
at least one server being configured to enable selection and sending by a sending user, using a sending communication device, of a sending user-selectable, at least partially audio communication, which was previously stored, said sending user-selectable at least partially audio communication being selectable by the sending user from a library accessible to said sending user via said sending communication device, said at least one server also being configured to:
enable playing to a receiving user using a receiving communication device, said sending user-selected, at least partially audio communication; and
enable automatically displaying to said receiving user, using said receiving communication device, at least one receiving user-selectable at least partially audio reply communication, which was previously stored and which is subject matter related to said sending user-selected at least partially audio communication.

22. A communications system according to claim 21 and wherein said server also is configured to enable replying by said receiving user, using said receiving communication device, by sending a receiving user selected, at least partially audio communication, which was previously stored.

23. A communications system according to claim 21 and wherein at least one of said sender-selectable at least partially audio communication and said receiving user-selectable reply communication comprises a Instance Specific, Sender Selected Message Bearing Audio/Video Notification (ISSSMBAVN).

24. A communications system according to claim 23 and wherein said ISSSMBAVN comprises an indication of an ISSSMBAVN classification.

25. A communications system according to claim 24 and wherein said server is configured to enable automatically displaying to said receiving user, using said receiving communication device, at least one receiving user-selectable reply communication, which was previously stored and which is subject matter related to said sending user-selected at least partially audio communication ISSSMBAVN employs said indication of said ISSSMBAVN classification.

26. A communications system according to claim 21 and wherein said server enables playing to said receiving user comprises enabling playing to said receiving user via said receiving communication device at least an audio portion of said at least partially audio communication when said receiving communication device is in an offline state.

27. A communications system according to claim 21 and wherein said server is operative such that:
said sending by said sending user comprises sending an originating Instance Specific, Sender Selected Message Bearing Audio/Video Notification (ISSSMBAVN); and
said replying by said receiving user, using said receiving communication device, comprises sending an initial response ISSSMBAVN.

28. A communications system according to claim 27 and wherein said server is operative such that:
said sending by said sending user also comprises sending a subsequent Instance Specific, Sender Selected Message Bearing Audio/Video Notification (ISSSMBAVN).

29. A communications system according to claim 28 and wherein said server is operative such that:
said replying by said receiving user, using said receiving communication device, also comprises sending a further response ISSSMBAVN.

30. A communications system according to claim 23 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.

31. A communications system comprising:
a server configured to enable sending, by a sending user using a sending communication device in an online state, a sending user-selected, at least partially audio communication, which was previously stored, said sending user-selected at least partially audio communication being selected by the sending user from a library accessible to said sending user via said sending communication device and playing to a receiving user using a receiving communication device in an offline state, at least an audio portion of said sender-selected, at least partially audio communication.

32. A communications system according to claim 31 and wherein said server is operative to enable selection by a sending user, using a sending communication device, of a sending user-selectable, at least partially audio communication, which was previously stored, said sending user-selectable at least partially audio communication being selectable by the sending user from a library accessible to said sending user via said sending communication device and to enable automatically displaying to said receiving user, using said receiving communication device, at least one receiving user-selectable at least partially audioreply communication, which was previously stored and which is subject matter related to said sending user-selected at least partially audio communication.

33. A communications system according to claim 31 and wherein said server is also operative to enable replying by said receiving user, using said receiving communication device, by sending a receiving user selected, at least partially audio communication, which was previously stored.

34. A communications system according to claim 31 and wherein at least one of said sender-selected at least partially audio communication and said receiving user-selected reply communication comprises a Instance Specific, Sender Selected Message Bearing Audio/Video Notification (ISSSMBAVN).

35. A communications system according to claim 34 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.

36. A communications system according to claim 35 and wherein said enabling automatically displaying to said receiving user, using said receiving communication device, at least one receiving user-selectable reply communication, which was previously stored and which is subject matter related to said sending user-selected at least partially audio communication ISSSMBAVN employs said indication of said ISSSMBAVN classification.

37. A communications system according to claim 31 and wherein:
said sending by said sending user comprises sending an originating Instance Specific, Sender Selected Message Bearing Audio/Video Notification (ISSSMBAVN); and
said replying by said receiving user, using said receiving communication device, comprises sending an initial response ISSSMBAVN.

38. A communications system according to claim 37 and wherein:
said sending by said sending user also comprises sending a subsequent Instance Specific, Sender Selected Message Bearing Audio/Video Notification (ISSSMBAVN).

39. A communications system according to claim 38 and wherein:
said replying by said receiving user, using said receiving communication device, also comprises sending a further response ISSSMBAVN.

40. A communications system according to claim 34 and wherein said ISSSMBAVN comprises:
a unique ISSSMBAVN ID which identifies an ISSSMBAVN and includes an indication of an ISSSMBAVN classification;
a unique SENDER ID which identifies said sending user's ISSSMBAVN Mobile Application; and
a unique RECEIVER ID which identifies said receiving user's ISSSMBAVN Mobile Application.
